(19) United States
(12) Patent Application Publication
(10) Pub. No.: US 2004/0258841 A1
(43) Pub. Date: Dec. 23, 2004

(54) Methods for depositing a thickfilm dielectric on a substrate

(76) Inventors: John F. Casey, Colorado Springs, CO (US); Lewis R. Dove, Monument, CO (US); Ling Liu, Colorado Springs, CO (US); James R. Drehle, Colorado Springs, CO (US); R. Frederick Rau JR., Colorado Springs, CO (US); Rosemary O. Johnson, Colorado Springs, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/600,600

(22) Filed: Jun. 19, 2003

(51) Int. Cl. B05D 3/02

(52) U.S. Cl. 427/372.2

(57) ABSTRACT

Disclosed is a method for depositing a thickfilm dielectric on a substrate. The method commences with the deposition of a first layer of thickfilm dielectric on the substrate, followed by an air drying of the first layer to allow solvents to escape, thereby increasing the porosity of the first layer. The first layer is then oven dried. Thereafter, additional layers of thickfilm dielectric are deposited on top of the first layer, with each layer being oven dried after it is deposited. The deposited layers are then fired.

### CROSS REFERENCE TO RELATED APPLICATIONS

This application is related to the application of John F. Casey, et al. entitled “Methods for Making Microwave Circuits”, filed on the same date as this application (Docket No. 10020707-1); and to the application of John F. Casey, et al. entitled “Methods for Forming a Conductor on a Dielectric”, also filed on the same date as this application (Docket No. 10030748-1). These applications are hereby incorporated by reference for all that they disclose.

### BACKGROUND

Microwave circuits have traditionally been built using individual thinfilm components (e.g., microstrips or bent microstrips) that are then assembled with one or more active circuit die into a machined metal package that is commonly referred to as “a gold brick”. These machined packages often make up a substantial fraction of the cost of the final completed circuit. For simpler brick machining and improved impedance matching, the thinfilm components are ideally the same thickness as the die itself. However, high frequency microwave circuits translate to high power . . . high power translates to high heat dissipation . . . high heat dissipation translates to very thin die . . . thin die translate to thin, thinfilm components . . . thin, thinfilm components translate to fragile substrates . . . and fragile substrates translate to low-yield, high-cost processing.

### SUMMARY OF THE INVENTION

One aspect of the invention is embodied in a method for depositing a thickfilm dielectric on a substrate. The method comprises depositing a first layer of thickfilm dielectric on the substrate, and then air drying the first layer to allow solvents to escape, thereby increasing the porosity of the first layer. The first layer is then oven dried. Thereafter, additional layers of thickfilm dielectric are deposited on top of the first layer, with each layer being oven dried after it is deposited. The deposited layers are then fired.

Other embodiments of the invention are also disclosed.

### BRIEF DESCRIPTION OF THE DRAWINGS

Illustrative embodiments of the invention are illustrated in the drawings, in which:

FIG. 1 illustrates a method for depositing a thickfilm dielectric on a substrate;

FIG. 2 illustrates a first layer of thickfilm dielectric deposited on a ground plane;

FIG. 3 illustrates additional layers of thickfilm dielectric deposited on the layer of thickfilm dielectric shown in FIG. 2;

FIG. 4 illustrates the layers of thickfilm dielectric shown in FIG. 3, after firing; and

FIG. 5 illustrates a conductor deposited on the thickfilm dielectric shown in FIG. 4.

### DETAILED DESCRIPTION OF THE INVENTION

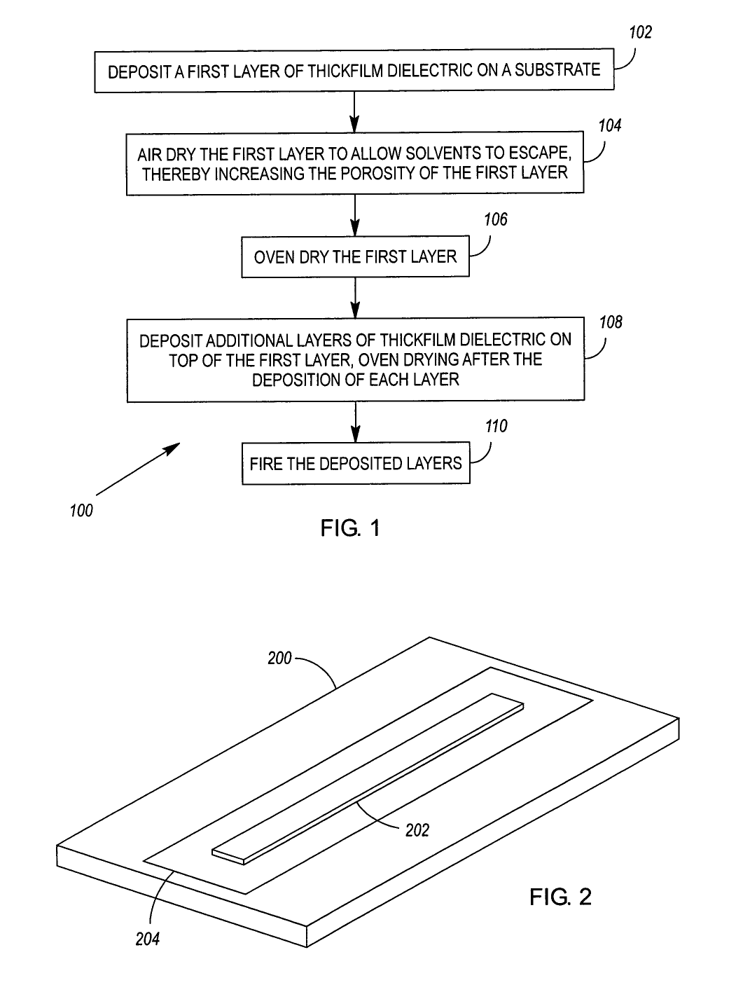

FIG. 1 illustrates a method 100 for depositing a thickfilm dielectric on a substrate. The method commences with the deposition 102 of a first layer of thickfilm dielectric on the substrate. After depositing the first layer of thickfilm dielectric, the layer is air dried for an extended time 104 to allow solvents to escape, thereby increasing the porosity of the layer. The layer is then oven dried 106. After depositing and drying the first layer, additional layers of thickfilm dielectric are deposited 108 on top of the first layer. After the deposition of each additional layer, including the last layer, the layer is oven dried. After all layers have been deposited and oven dried, the deposited layers are fired 110.

FIGS. 2-4 illustrate an exemplary application of the above method. FIG. 2 illustrates a substrate 200 that, by way of example, may be a 40 mil lapped alumina ceramic substrate. The substrate 200 comprises a ground plane 204 on a top surface thereof, but need not. If a ground plane is provided, the ground plane could alternately be located on the bottom surface of the substrate, or even interior to the substrate. For purposes of this description, the phrase “ground plane” is intended to cover ground planes that substantially or completely cover a surface, as well as ground traces that function as ground planes with respect to one or more particular conductors.

In accordance with the FIG. 1 method, a first layer of thickfilm dielectric 202 is deposited on the substrate 200. In one embodiment, the dielectric 202 is the KQ CL-90-7858 dielectric (a glass dielectric) available from Heraeus Cermalloy (24 Union Hill Road, West Conshohocken, Pa., USA). However, the dielectric 202 may be another dielectric and, particularly, may be another KQ dielectric, glass dielectric, or other dielectric with suitable electrical properties.

KQ CL-90-7858 prints like a standard thickfilm paste; has a dielectric constant of 3.95 (compared with 9.6 for alumina ceramic); has a loss tangent of 2E-4; may be fired in air in a conventional belt furnace at 850° C.; is optically transparent after firing; and is compatible with DuPont QG150 gold (available from DuPont (1007 Market Street, Wilmington, Del., USA)). The low loss and low dielectric constant of KQ CL-90-7858 makes it particularly suitable for building microwave circuits (e.g., microwave transmission lines).

KQ CL-90-7858 may be deposited on a substrate 200/204 via screen printing. In practice, it has been found useful to thin KQ CL-90-7858 to a viscosity of 18.0±2.0 prior to deposition, and then deposit the thinned dielectric by printing it through a stainless steel screen (e.g., 200 mesh, 1.6 mil wire, 0.8 mil emulsion).

If the deposited dielectric layer 202 is immediately oven dried, it tends to crack as it dries. This is believed to be a result of trapped gasses creating abnormal pressures interior to the dielectric layer. It has been discovered, however, that an extended air drying of the dielectric layer allows solvents to escape from the layer, thereby increasing the porosity of the layer. For a first layer of KQ CL-90-7858 dielectric deposited on a gold plated alumina ceramic substrate, and having a dry print thickness of about 1.5 mils, an air dry of at least 45 minutes tends to alleviate cracking when the layer is oven dried. Following air dry, the layer 202 may be subjected to a standard oven dry (e.g., an oven drying at a peak temperature of about 150° C. for about fifteen minutes).

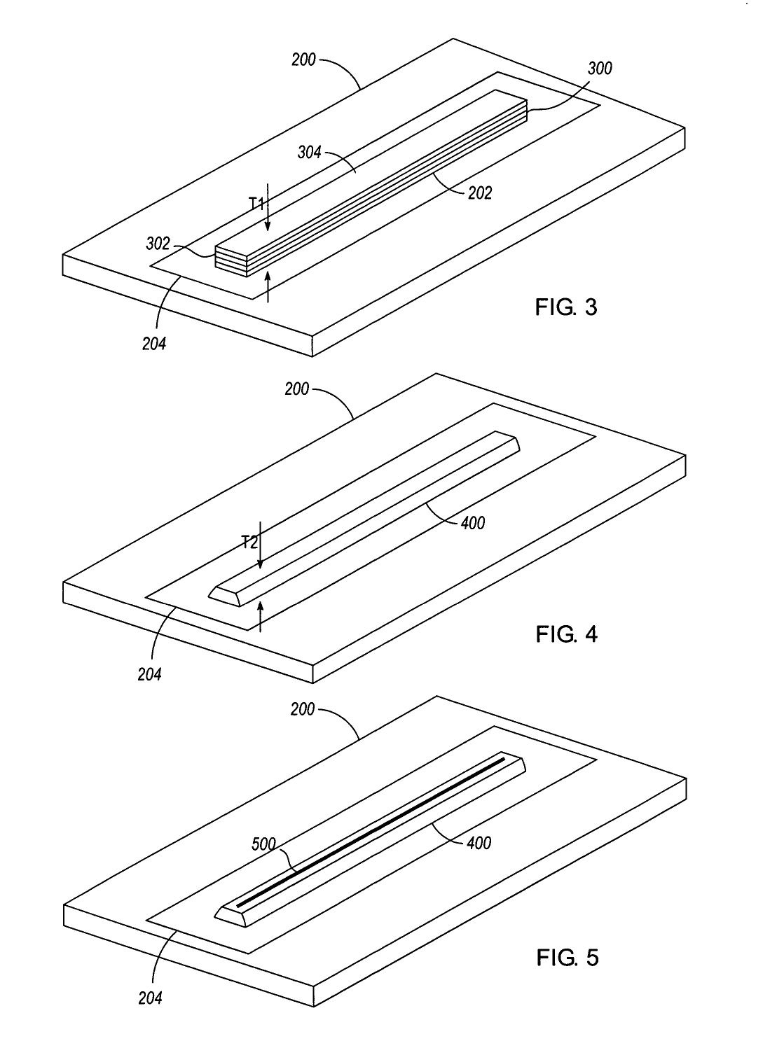

After air drying and oven drying the first layer of thickfilm dielectric 202, additional layers of thickfilm dielectric 300, 302, 304 may be deposited on top of the first (using, for example, the same procedure that is used to deposit the first layer of thickfilm dielectric on the substrate; see FIG. 3). Each successive layer may be subjected to a quick oven dry of about five minutes prior to deposition of the next layer. Given that the first layer of dried but not fired dielectric is likely to be substantially more porous than the substrate 200/204, and given that additional layers of dielectric 300-304, being of like composition, tend to form a bond to one another that is stronger than the bond between the first layer 202 and the substrate 200/204, extended air drying of the additional layers of thickfilm dielectric is typically unnecessary, and can be dispensed with to shorten the manufacturing process.

After all of the layers of thickfilm dielectric 202, 300-304 have been deposited and dried, the layers are fired (see fired dielectric 400, FIG. 4). If the layers comprise KQ CL-90-7858 dielectric, the firing may be performed using a commonly used thickfilm firing cycle (e.g., The layers may be air fired in a conventional belt furnace at a peak temperature of about 850° C. for about 10 minutes dwell at peak. A slow controlled ramp up in temperature may be incorporated in order to adequately outgas and burn off all organic materials. Likewise, a slow controlled ramp down in temperature may be used to prevent substrate breakage.).

During firing, the deposited dielectric layers 202, 300-304 will shrink (i.e., due to solvents and organic binders being burned away). As a result, a desired final dielectric thickness (or “fired print thickness”; T2, FIG. 4) may only be achieved by depositing enough dielectric layers 202, 300-304 to achieve a dry print thickness (T1, FIG. 3) that is greater than the desired final dielectric thickness. By way of example, the aforementioned KQ CL-90-7858 will shrink upon firing to approximately 60% of its original unfired thickness. Other dielectrics may have greater or lesser shrink factors than this, but the shrink factor will typically be consistent for a given manufacturer's specific product type. Both the dry print thickness and the fired print thickness of the deposited layers may be measured using a drop-gauge micrometer or stylus profilometer.

Since there are limits on how precisely the height of a thickfilm layer may be controlled during deposition of the thickfilm layer, and because the deposition of successive thickfilm layers only multiplies the effects of any thickfilm height fluctuations, it is desirable in some cases to deposit layers of thickfilm dielectric until a dry print thickness (T1) in excess of a desired dry print thickness is achieved. A precise final dielectric thickness (T2) may then be achieved in a variety of ways. One way is to planarize the deposited layers 202, 300-304 to a desired dry print thickness prior to firing the deposited layers and use the known shrink factor to achieve the desired final result. In this case, a useful equation is “Dry Print Thickness=Fired Print Thickness/Shrink Factor”. With care, a simple cutout metal shim pattern may be used to achieve a final thickness of better than +/−0.4 mils for a 10 mil thick dielectric. A more precise, although more expensive, way is to grind the fired layers to a desired final dielectric thickness. With this method, a 10 mil thick dielectric lay can be controlled to better than +/−0.1 mils variation. The ground surface may then be polished to remove any scratches or, if the dielectric is KQ CL-90-7858, the ground dielectric 400 may be refired to smooth the ground surface and edges (i.e., since KQ CL-90-7858 tends to reflow to a small degree when refired).

It should be noted that, for KQ CL-90-7858 dielectric, a dry print thickness of about 11 mils is required to obtain a final (fired) dielectric thickness of about 5 mils when the grinding method is utilized.

After depositing the thickfilm dielectric 400 over the ground plane 204, a conductor 500 may be formed on the thickfilm dielectric (see FIG. 5). By way of example, such a conductor may be formed by means of depositing a conductive thickfilm on the dielectric 400 (e.g., via screen printing, stencil printing or doctor blading) and then patterning and etching the conductor in the conductive thickfilm. Alternately, the conductor 500 may be formed as described in the methods disclosed in the afore-mentioned patent application of John F. Casey, et al. entitled “Methods for Forming a Conductor on a Dielectric”.

The above techniques may be used in at least some embodiments of the invention to form high quality dielectric layers that are much thicker than those produced by conventional thickfilm processes. Thicker dielectric layers translate into wider conductor stripes for a given desired value of microwave impedance, and wider stripes translate into more precise lines and less signal degradation due to conductor loss.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1: A method for depositing a thickfilm dielectric on a substrate, comprising:
a) depositing a first layer of thickfilm dielectric on the substrate;
b) air drying the first layer to allow solvents to escape, thereby increasing the porosity of the first layer;
c) oven drying the first layer;
d) depositing additional layers of thickfilm dielectric on top of the first layer, oven drying after the deposition of each additional layer; and
e) firing the deposited layers.

2: The method of claim 1, wherein the first layer is air dried for at least 45 minutes.

3: The method of claim 1, wherein said oven drying of the first layer comprises oven drying at a peak temperature of about 150° C. for about fifteen minutes.

4: The method of claim 3, wherein said oven drying of the additional layers comprises oven drying at a peak temperature of about 150° C. for about fifteen minutes.

5: The method of claim 1, wherein said firing comprises firing at a peak temperature of about 850° C.

6: The method of claim 1, further comprising measuring a dry print thickness of the deposited layers to determine if a desired final dielectric thickness will be achieved after the deposited layers are fired.

7: The method of claim 6, wherein the dry print thickness of the deposited layers is measured using one of a drop-gauge micrometer or stylus profilometer.

8: The method of claim 6, wherein the dry print thickness of the deposited layers is measured using a drop-gauge micrometer.

9: The method of claim 1, wherein the layers of thickfilm dielectric comprise a KQ dielectric.

10: The method of claim 9, wherein the KQ dielectric is KQ CL-90-7858 dielectric.

11: The method of claim 10, further comprising, after firing, grinding the deposited layers to a desired final dielectric thickness, and then refiring the deposited layers to smooth the ground surface and edges.

12: The method of claim 1, wherein the layers of thickfilm dielectric comprise a glass dielectric.

13 (canceled)

14: The method of claim 1, wherein the layers of thickfilm dielectric are deposited by printing the layers through a stainless steel screen having 200 mesh, 1.6 mil wire, 0.8 mil emulsion.

15: The method of claim 1, further comprising depositing additional layers of thickfilm dielectric until a dry print thickness in excess of a desired dry print thickness is achieved, and then planarizing the deposited layers to a desired dry print thickness prior to firing the deposited layers.

16: The method of claim 1, further comprising, after firing, grinding the deposited layers to a desired final dielectric thickness, and then polishing the ground surface.

17: The method of claim 1, wherein the first layer is air dried for at least 45 minutes, wherein said oven drying of the first layer comprises oven drying at a peak temperature of about 150° C. for about fifteen minutes, wherein said oven drying of each additional layer comprises drying at a peak temperature of about 150° C. for about five minutes, and wherein said firing comprises firing at a peak temperature of about 850° C.

18: The method of claim 17, wherein the thickfilm dielectric comprises KQ CL-90-7858 dielectric.

19 (canceled)

20: The method of claim 18, further comprising, after firing, grinding the deposited layers to a desired final dielectric thickness, and then refiring the deposited layers to smooth the ground surface and edges.
